(19) United States
(12) Patent Application Publication
(10) Pub. No.: US 2005/0149357 A1
(43) Pub. Date: Jul. 7, 2005

(54) Computerized system and method for generating and satisfying health maintenance item expectations in a healthcare environment

(76) Inventors: Jeffrey S. Doyel, Shawnee, KS (US); Jennifer A. Ducey, Fairway, KS (US); D. Allan Shoup, Kansas City, MO (US); James J. Wagner, Overland Park, KS (US)

Correspondence Address: SHOOK, HARDY & BACON L.L.P., 2555 GRAND BOULEVARD, KANSAS CITY, MO, 64108-2613, US

(21) Appl. No.: 10/750,478

(22) Filed: Dec. 31, 2003

(51) Int. Cl. G06F 17/60

(52) U.S. Cl. 705/2

(57) ABSTRACT

A computerized method and system for automatically determining whether an expectation for a health maintenance item has been satisfied is provided. The system generates an expectation for a health maintenance item for a person and the automatically determines whether the expectation has been satisfied. In another embodiment, a computerized method and system generating satisfiers for an expectation for a health maintenance item is provided. The system obtains one or more unsatisfied expectations for a person. The system also obtains possible satisfiers for each of the one or more unsatisfied expectations and displays the possible satisfiers for each of the one or more unsatisfied expectations.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates generally to the field of computer software. Particularly, the invention relates to a computerized system and method for generating and satisfying health maintenance item expectations in a healthcare environment.

### BACKGROUND OF THE INVENTION

Recently, preventative medicine has become an integral part of healthcare. Recommendations by numerous boards and preventative services have been developed for numerous healthcare screening tests and health maintenance items. Depending on the patient's age, gender and health conditions, multiple tests may be recommended. The American Medical Association (AMA) and U.S. Preventative Services Task Force issue recommendations for health maintenance that are often supported by clinical evidence. Health maintenance items include tests, screenings, procedures and treatments such as blood pressure screening, colorectal exams, cholesterol screening, routine physical exams, mammography's, pap smears, testicular exams and drug therapy. Since these health maintenance items are typically expected to be performed or otherwise satisfied in a timely manner, the appointed time for performance of the tasks associated with the clinical items is known as an “expectation.”

Currently, the preventative medicine schedule of expectations for health maintenance items for individual patients are determined by the individual physicians and are tracked on that patient's paper chart. As such, vital information regarding the healthcare maintenance items is not preserved and some healthcare maintenance items may be overlooked.

When health maintenance items are stored in a computerized environment, they are stored in a stand-alone system. These systems cannot access information from any other system. Because these systems are disparate computing systems they cannot automatically satisfy expectations for health maintenance items using information that has already been documented for the patient. For instance, the system cannot search another database to determine that a particular test has been ordered for the patient that would satisfy the expectation. These systems require a user to open a new record for each health maintenance item to indicate that the expectation has been satisfied.

These systems also do not provide possible satisfiers for the expectations for the health maintenance items. In other words, these systems do not provide a list of possible tests or therapies that may be used to satisfy an expectation for a health maintenance item. The user or healthcare provider has to determine what they believe constitutes an adequate satisfier for the expectation for the health maintenance item for the patient.

What is needed is a system and method for generating expectations for health maintenance items for a patient, automatically determining whether the expectation has been satisfied and providing possible satisfiers if the expectation has not been satisfied.

### SUMMARY OF THE INVENTION

In one embodiment of the present invention, a computerized method and system for automatically determining whether an expectation for a health maintenance item has been satisfied is provided. The system generates an expectation for a health maintenance item for a person and the system automatically determines whether the expectation has been satisfied.

In another embodiment of the present invention, a computerized method and system for generating satisfiers for an expectation for a health maintenance item is provided. The system obtains one or more unsatisfied expectations for a person. The system also obtains possible satisfiers for each of the one or more unsatisfied expectations and displays the possible satisfiers for each of the one or more unsatisfied expectations.

In still another embodiment of the present invention, a computerized method and system for determining whether a patient may experience an adverse reaction to a satisfier chosen for an expectation for a health maintenance item is provided. The system receives a satisfier for an expectation for a health maintenance item. The system then obtains healthcare information for a person and determines whether the person may have an adverse reaction to the satisfier. If the system determines the person may have an adverse reaction to the satisfier, the system warns of the possible adverse reaction to the satisfier.

### BRIEF DESCRIPTION OF THE SEVERAL VIEWS OF THE DRAWINGS

The present invention is described in detail below with reference to the attached drawing figures, wherein:

FIG. 1 is a block diagram of a computing system in accordance with an embodiment of the present invention;

FIG. 2 is a flowchart representative of a computer program for storing and displaying satisfied expectations for healthcare maintenance items for a patient in accordance with an embodiment of the present invention;

FIG. 3 is a flowchart representative of a computer program for storing satisfied expectations for healthcare maintenance items for a patient in accordance with an embodiment of the present invention;

FIG. 4 is a screenshot illustrating an exemplary implementation of displaying expectations for healthcare maintenance items for a patient;

FIG. 5 is a screenshot illustrating an exemplary implementation of displaying satisfied and unsatisfied expectations for health maintenance items for a patient;

FIG. 6 is a screenshot illustrating an exemplary implementation of displaying detailed information for a satisfied expectation for health maintenance items for a patient.

FIG. 7 is a screenshot illustrating an exemplary implementation of displaying unsatisfied expectations for health maintenance items for a patient;

FIG. 8 is a screenshot illustrating an exemplary implementation of selecting a satisfier for an expectation;

FIG. 9 is a screenshot illustrating an exemplary implementation of a satisfier for an expectation of a health maintenance item;

FIG. 10 is a screenshot illustrating an exemplary implementation of a satisfier for a health maintenance expectation;

FIG. 11 is a screenshot illustrating an exemplary implementation of recording satisfaction information regarding an expectation;

FIG. 12 is a screenshot illustrating an exemplary implementation of recording that a patient is unavailable to satisfy an expectation;

FIG. 13 is a screenshot illustrating an exemplary implementation of recording a patient refusal for a satisfier of an expectation; and

FIG. 14 is a screenshot illustrating an exemplary implementation of recording the expiration of an expectation.

### DETAILED DESCRIPTION OF THE INVENTION

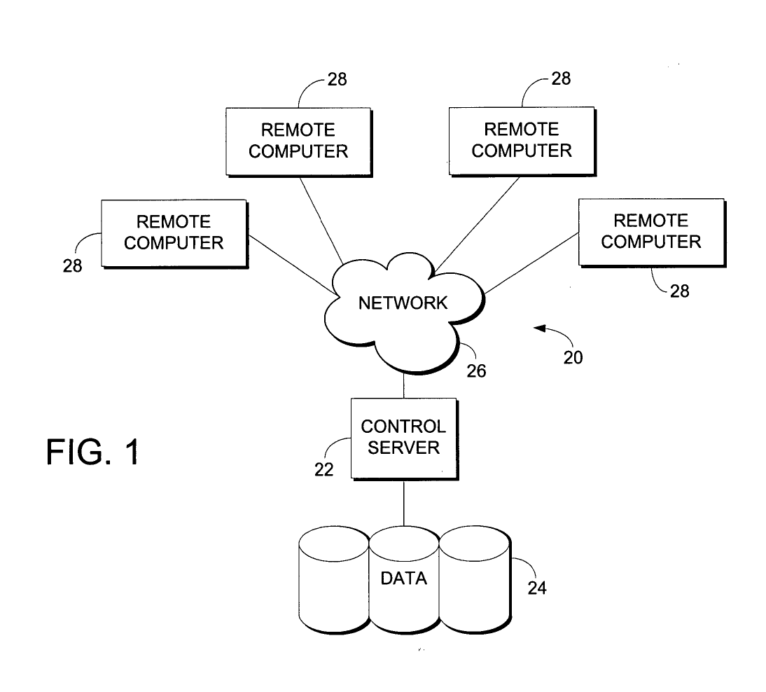

The present invention provides a method and system for storing and displaying satisfied and unsatisfied expectations for health maintenance items for a patient in a computing environment. The present invention also provides a method for generating and satisfying health maintenance item expectations. FIG. 1 illustrates an example of a suitable medical information computing system environment 20 on which the invention may be implemented. The medical information computing system environment 20 is only one example of a suitable computing environment and is not intended to suggest any limitation as to the scope of use or functionality of the invention. Neither should the computing environment 20 be interpreted as having any dependency or requirement relating to any one or combination of components illustrated in the exemplary environment 20.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include, but are not limited to, routines, programs, objects, components, data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media, including memory storage devices.

With reference to FIG. 1, an exemplary medical information system for implementing the invention includes a general purpose computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 22 typically includes therein or has access to a variety of computer readable media, for instance, database cluster 24. Computer readable media can be any available media that can be accessed by server 22, and includes both volatile and nonvolatile media, removable and nonremovable media. By way of example, and not limitation, computer readable media may comprise computer storage media and communication media. Computer storage media includes both volatile and nonvolatile, removable and nonremovable media implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared and other wireless media. Combinations of any of the above should also be included within the scope of computer readable media.

The computer storage media, including database cluster 24, discussed above and illustrated in FIG. 1, provide storage of computer readable instructions, data structures, program modules, and other data for server 22.

Server 22 may operate in a computer network 26 using logical connections to one or more remote computers 28. Remote computers 28 can be located at a variety of locations in a medical environment, for example, but not limited to, clinical laboratories, hospitals, other inpatient settings, a clinician's office, ambulatory settings, medical billing and financial offices, hospital administration, and home healthcare environment. Clinicians include, but are not limited to, the treating physician, specialists such as surgeons, radiologists and cardiologists, emergency medical technicians, physician's assistants, nurse practitioners, nurses, nurse's aides, pharmacists, dieticians, microbiologists, and the like. The remote computers may also be physically located in non-traditional medical care environments so that the entire healthcare community is capable of integration on the network. Remote computers 28 may be a personal computer, server, router, a network PC, a peer device, other common network node or the like, and may include some or all of the elements described above relative to server 22. Computer network 26 may be a local area network (LAN) and/or a wide area network (WAN), but may also include other networks. Such networking environments are commonplace in offices, enterprise-wide computer networks, intranets and the Internet. When utilized in a WAN networking environment, server 22 may include a modem or other means for establishing communications over the WAN, such as the Internet. In a networked environment, program modules or portions thereof may be stored in server 22, or database cluster 24, or on any of the remote computers 28. For example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, satellite dish, scanner, or the like. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention.

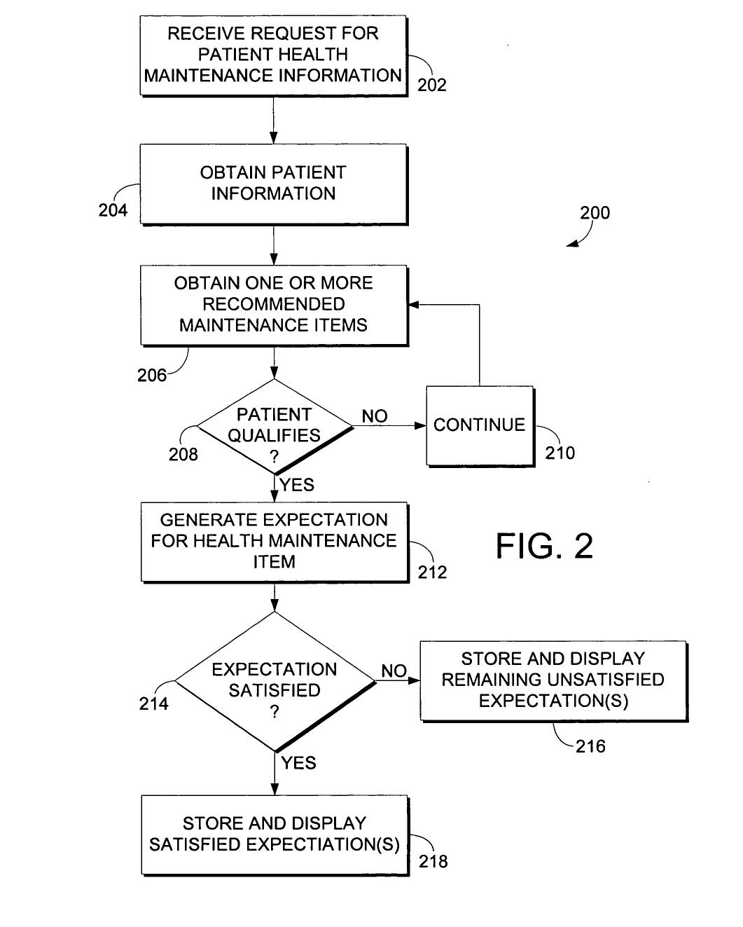

With reference to FIG. 2, a method 200 for automatically satisfying, storing and displaying satisfied and unsatisfied expectations for health maintenance items for a patient is provided. At block 202, the system receives a request for health maintenance information for a patient. The request may be received from a user or from another system. At block 204, the system obtains patient information. Patient information/data may be obtained in any number of ways, including from a database table and/or the patient's electronic medical record stored in an integrated database.

At block 206, the system obtains recommended health maintenance items from a database and/or table. Health maintenance items may include, but are not limited to, tests, screenings, procedures, therapies and medications recommended to prevent certain persons from developing certain health conditions or worsening pre-existing health conditions. The system may obtain a list of recommended health maintenance items from a database containing pre-defined health maintenance items specified by healthcare organizations and may vary. In another embodiment, the recommended health maintenance items may be those set forth by the American Medical Association (AMA) or U.S. Preventative Services Task Force. Health maintenance recommendations may be added or deleted from the list of recommended health maintenance items.

At block 206, the system also obtains the patient factors that the system applies to the obtained patient information to determine whether the patient qualifies for any of the recommended health maintenance items. These patient factors may include information about the patient such as the patient's age, gender, health conditions, health problems, diagnoses, documented procedures for the patient, lifestyle conditions, such as smoking and weight, and genetic predispositions. Again, these factors may be obtained from a database containing pre-defined patient factors specified by the healthcare organization or may be recommended factors set forth by an organization such as the AMA or U.S. Preventative Services Task Force. These patient factors may vary based on current health maintenance recommendations.

At block 208, the system determines whether the patient qualifies for any of the recommended health maintenance items. The system determines, based on patient information/data, whether the patient satisfies enough of the predefined factors to qualify for the health maintenance item. For example, at block 206, the system obtains the health maintenance item and related patient factors. Assume the health maintenance item is for the patient to receive a mammography once a year. The factors that qualify the patient for a mammography include the gender of the patient (female) and the patient's age (over forty years old). Thus, based on these factors, if the system determines from the patient's information that the patient is a woman more than forty years old, the system determines that the patient qualifies for the health maintenance item.

If at block 208 the patient does not qualify for the recommended health maintenance item, the system continues at block 210. From block 210, the system may be exited or may proceed to block 206 again to determine whether the patient qualifies for any other recommended health maintenance items.

If at block 208 the system determines that the patient qualifies for the recommended health maintenance item, the system generates an expectation for the patient to receive the health maintenance item at block 212. In one embodiment, a generating module of the system generates an expectation for a health maintenance item for a person. Using the example above, a patient who is a forty-eight (48) year old woman would qualify for a mammography examination once yearly, and an expectation for this health maintenance item would be generated.

At block 214 the system determines whether the expectation has been satisfied. The items that may satisfy an expectation may be obtained from a database containing pre-defined satisfiers for one or more expectations and are specified by the healthcare organization or may be recommended satisfiers set forth by an organization such as the AMA or U.S. Preventative Services Task Force.

The system automatically searches an integrated medical database or another system for a pre-defined satisfier of the expectation to determine whether or not the expectation is satisfied. This is done automatically without any user interaction. For example, the system may search the integrated medical database of a healthcare organization to determine whether and where the expectation has been satisfied. In one embodiment, a determining module of the present invention automatically determines whether the expectation has been satisfied.

The expectation may be defined to be satisfied in any number of ways, including determining that an order has been placed, placing an order, determining that a procedure has been documented, documenting a procedure, determining a result value exists for the expectation, or documenting a result for the expectation. An order includes placing a request for the patient to receive a procedure, medication or any other type of treatment or test. In the example, the expectation for a mammography is satisfied if the patient has had a mammography within the last year.

If at block 214 the system determines that the expectation has been satisfied, the system stores and displays the satisfied expectation at block 218. The system may store the satisfied expectation in a variety of ways. Preferably, the system stores the satisfied expectation in a database, table and/or patient's electronic medical record in an integrated database in a healthcare environment.

If at block 214 the system determines that the expectation is not satisfied, at block 216 the system stores and displays the remaining unsatisfied expectation.

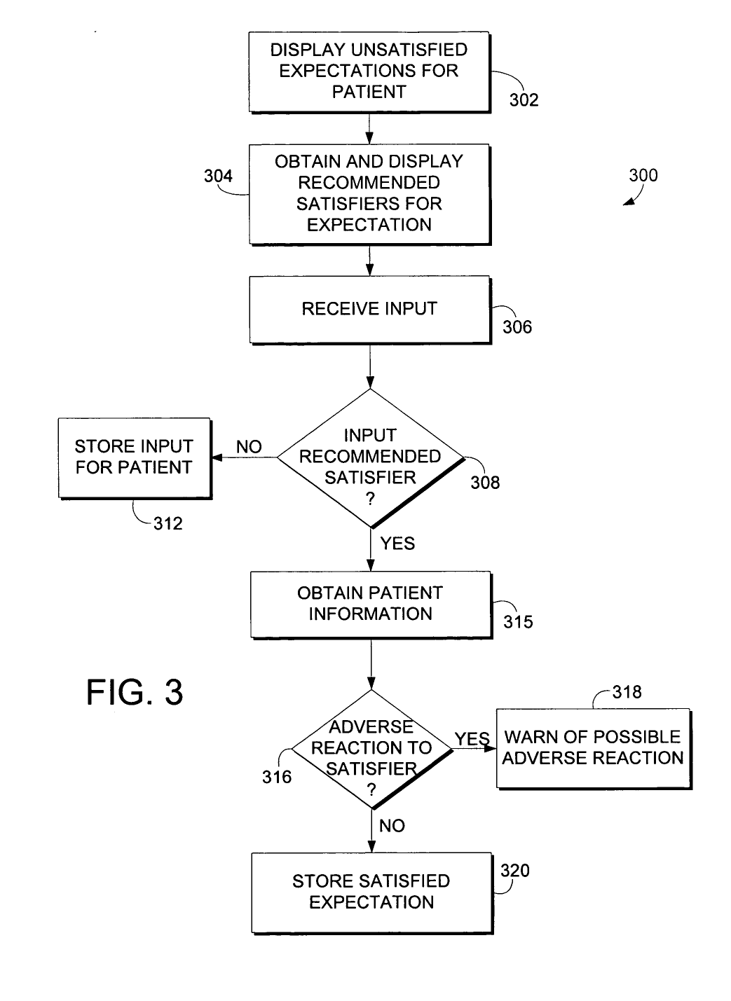

With reference to FIG. 3, a method 300 is shown for storing satisfied expectations for health maintenance items and warning of possible adverse reactions to satisfiers of health maintenance items. In one embodiment of the present invention, an obtaining module of the system obtains one or more unsatisfied health maintenance item expectations for a person. At block 302, the system obtains and displays the unsatisfied expectations for the patient. At block 304, the system obtains the recommended satisfiers for each expectation and displays them. A second obtaining module of the system may obtain possible satisfiers for each of the one or more unsatisfied expectations.

Again, the items that may satisfy an expectation may be obtained from a database containing pre-defined satisfiers for one or more expectations. For example, the system may determine that the patient qualifies for colorectal screening and create an expectation for the patient to receive colorectal screening. The system obtains the recommended satisfiers to satisfy the expectation for colorectal screening from a database and displays the satisfiers.

The satisfiers the system obtains from a database for colorectal screening may include things such as a hemoccult result, a sigmoidoscopy result, a colonoscopy result and a hemoccult performed elsewhere. The system of the present invention displays the recommended satisfiers for each unsatisfied expectation for a patient. In one embodiment, a displaying module of the system displays the possible satisfiers for each of the one or more unsatisfied expectations. At block 306, the system receives input from a user or another system. A receiving module of the system may receive a satisfier for an expectation for a health maintenance item.

The input may be entered in any number of ways including receiving a selection by the user of a recommended satisfier. At block 308, the system determines whether the input is a recommended satisfier of the expectation for the patient.

If the input received is a recommended satisfier at block 308, the system proceeds to decision block 315. At block 315 the system obtains healthcare information for the patient. In one embodiment, an obtaining module of the system obtains healthcare information for the patient. The patient information is obtained from a database or the patient's electronic medical record.

At decision block 316, the system determines whether or not the patient may have an adverse reaction to the recommended satisfier received. In one embodiment a determining module of the system determines whether the person may have an adverse reaction to the satisfier. The system determines whether the person may experience an adverse reaction by comparing patient information/data obtained from a database or the patient's electronic medical record with information obtained from a database regarding drug-drug interactions, allergies and adverse reactions.

For example, a recommended satisfier for a patient with a heart disease prevention expectation may be aspirin therapy. However, if at block 316 the system determines that the patient is allergic to aspirin at block 318, the system would warn of a possible adverse reaction to the recommended satisfier. In one embodiment, a warning module of the system warns of the possible adverse reaction to the satisfier.

If at block 316 the system determines that the patient is not likely to have an adverse reaction to the input satisfier at block 320, the system stores the satisfied expectation for the patient. The system may store the satisfied expectation in any of a variety of ways, including in a database, table and/or the patient's electronic medical record.

If at block 308 the input received is not a recommended satisfier, at block 312 the system stores the input for the patient. The input may be any of a variety of information. For example, the input may be the patient's refusal to receive the recommended satisfier, input noting that the expectation has been satisfied elsewhere, input that the patient is unavailable, or input that the expectation should be expired permanently due to the patient's condition or some other reason.

The following example is merely illustrative and does not limit the present invention. One of skill in the art would understand that other expectations and satisfiers are known and within the scope of the present invention. In operation, by way of example, the system receives a request for a health maintenance schedule for a fictitious patient, Jim Nasium, at block 202 of FIG. 2. At block 204, the system obtains information for Jim Nasium from his electronic medical record from an integrated database. At block 206, the system obtains a list of recommended health maintenance items. At block 208, the system determines whether or not Jim Nasium qualifies for each of the recommended maintenance items. Based on Jim Nasium's age, health condition, and gender, the system determines that he qualifies for the following health maintenance items: influenza vaccination, ischemic heart disease prevention, and colorectal screening.

At block 212, the system generates an expectation for each of the health maintenance items. A separate expectation is generated for the influenza vaccination, the ischemic heart disease prevention and the colorectal screening. At block 214, the system searches the patient's electronic medical record and the integrated databases and determines that none of the three expectations have been satisfied. Thus, at block 216, the system stores and displays the three unsatisfied expectations.

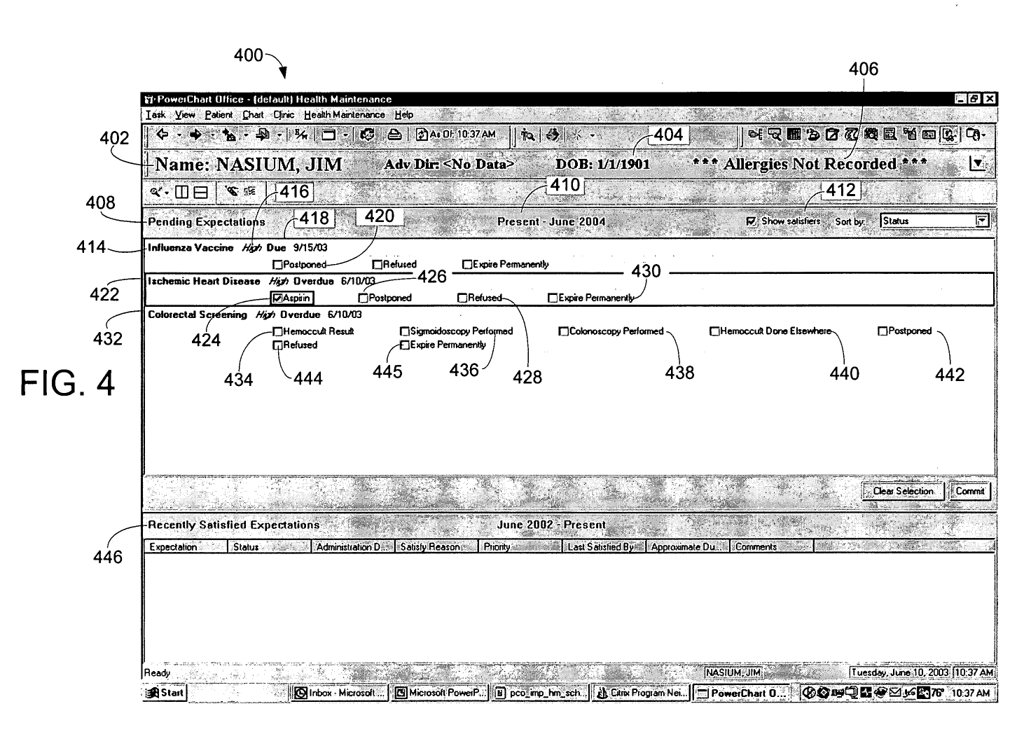

With reference to FIG. 3, the system has displayed the unsatisfied expectations for fictitious patient Jim Nasium at block 302 and at block 304 the system determines and displays recommended satisfiers for each expectation. Turning to FIG. 4, the system displays a customized health maintenance schedule 400 for fictitious patient Jim Nasium 402. The user may access the list of health maintenance items that are due for the patient. The customized health maintenance schedule 400 also includes the patient's date of birth 404 and any recorded allergies 406 for the patient. The pending expectations for health maintenance items for the patient are displayed in field 408. Field 408 lists pending expectations for the patient from the present date of Jun. 10, 2003 to June 2004. Block 412 is checked so that satisfiers for each expectation are shown.

As can be seen from the display, patient Jim Nasium 402 has three pending expectations for the influenza vaccination 414, ischemic heart disease prevention 422, and colorectal screening 432. For each pending expectation, the priority 416 of the expectation is listed and the due date of satisfying the expectation 418 is also shown. Referring to pending expectation for ischemic heart disease prevention 422, the health maintenance item is a high priority and is overdue. The satisfiers for ischemic heart disease are displayed. The satisfiers include aspirin treatment 422. The aspirin therapy for ischemic heart disease prevention 422 may also be postponed 426, may be refused by the patient 428, or may be expired permanently 430 due to the patient's health condition. For example, the expectation may be expired permanently because the patient has a terminal condition.

With reference to the expectation for colorectal screening 432, the expectation may be satisfied by a hemoccult result 434, the performance of a sigmoidoscopy 436, the performance of a colonoscopy 438 or input that a hemoccult was done elsewhere 440. Input may also be entered for the colorectal screening expectation that it has been postponed 442, refused by the patient 444, or should be expired permanently 445. Recently satisfied expectations for the patient are shown below in field 446.

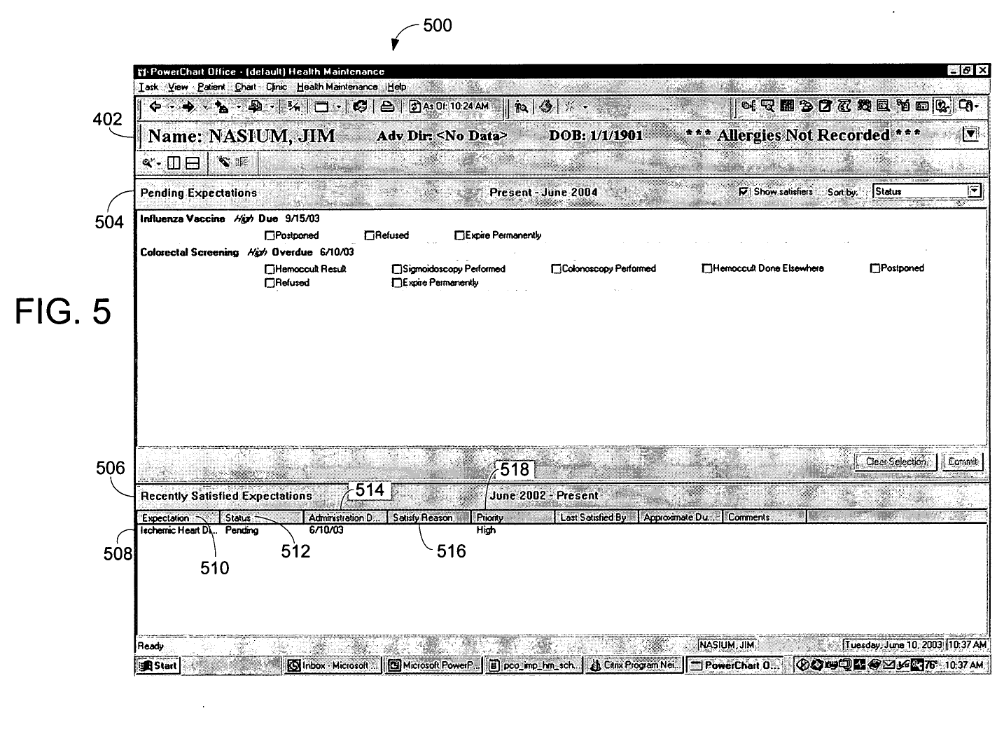

Continuing the example above, a healthcare provider selects aspirin therapy 424 to satisfy the expectation for health maintenance item for ischemic heart disease prevention 422. Turning to FIG. 5, the system displays the customized health maintenance schedule 500 with the updated satisfied expectation for fictitious patient Jim Nasium 402. The customized health maintenance schedule shows that Jim Nasium only has two pending expectations for the influenza vaccination and colorectal screening. In the lower portion of the field 506, the system lists the recently satisfied expectation for ischemic heart disease prevention 508. The recently satisfied expectations field 506 includes information regarding the type of expectation 510, the status of the expectation 512, the administration date of the expectation 514, the reasons the expectation is satisfied 516, and the priority of the expectation 518. Thus, the expectation for ischemic heart disease prevention for patient Jim Nasium is pending an administration date of Jun. 10, 2003 and the priority of the expectation is high.

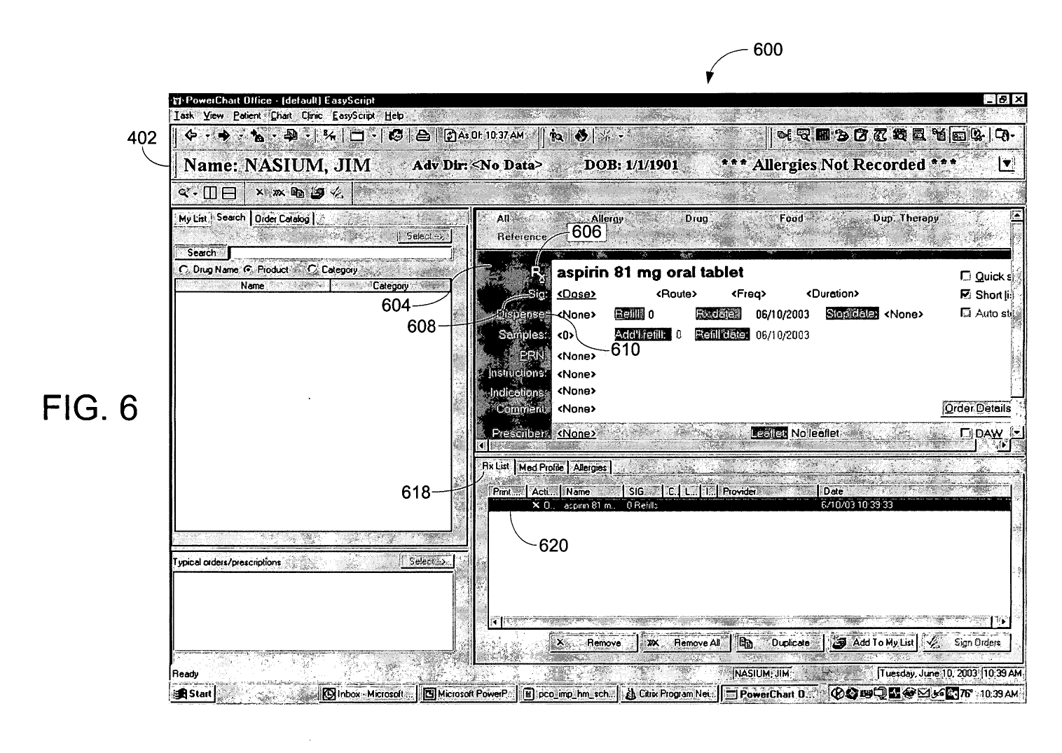

More information may be obtained for a recently satisfied expectation by selecting the expectation. For example, the expectation for ischemic heart disease prevention being satisfied by aspirin therapy 508 may be selected to obtain more information regarding the aspirin therapy. With reference to FIG. 6, the system displays detailed information 600 for the satisfier for the health maintenance item selected. The detailed information for patient, Jim Nasium 402, is displayed in field 604. The information includes the prescription 606, information regarding the dose, route, frequency and duration 608 of the prescription and information regarding dispensing the prescription 610. Other prescriptions prescribed to the patient are displayed on a prescription list 618. As can be seen on the prescription list 618, patient Jim Nasium 602 has been prescribed aspirin 620. There are no other prescription medications being administered to the patient at this time.

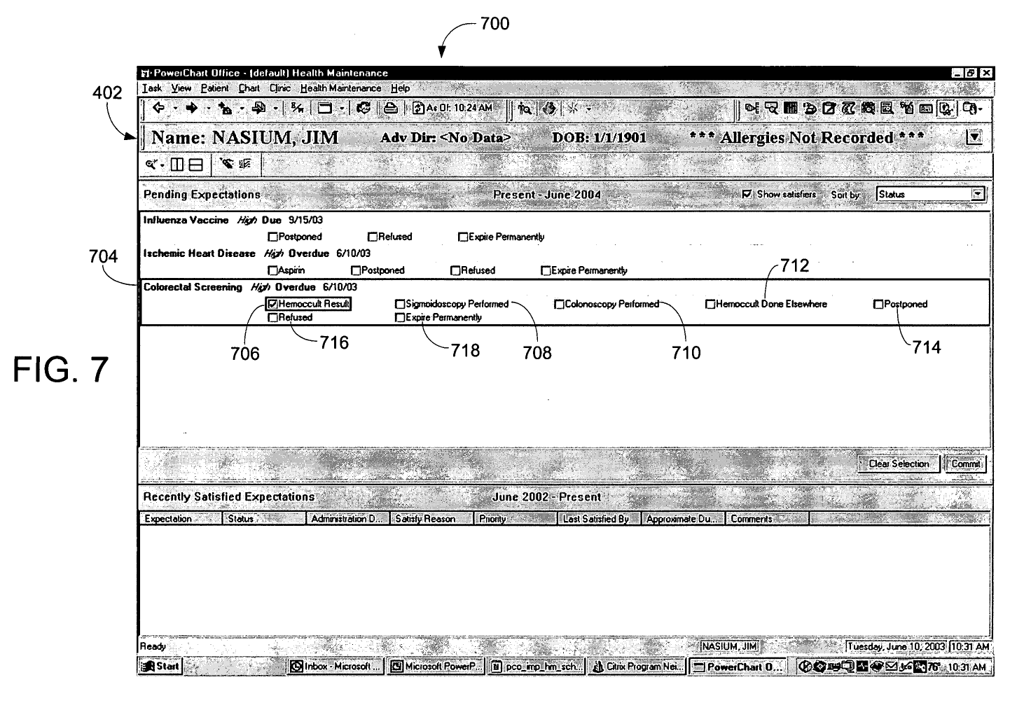

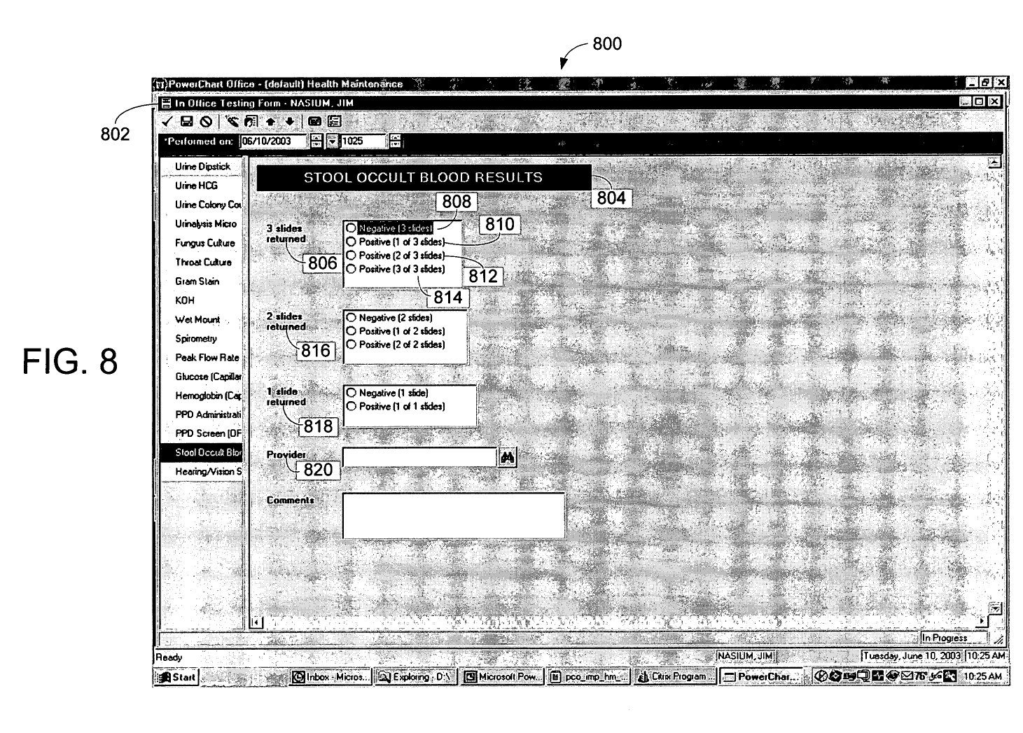

Turning to FIG. 7, a customized health maintenance schedule 700 for fictitious patient Jim Nasium 402 is shown. The pending expectations for health maintenance items for the patient are displayed. Colorectal screening 704 is one of three expectations listed for the patient. The satisfiers for the expectation 704 include hemoccult test results 706, sigmoidoscopy results 708, colonoscopy results 710 and that a hemoccult was performed elsewhere 712. The system also allows a user to indicate that the colorectal screening expectation has been postponed 714, has refused by the patient 716 or that it should be expired permanently 718. If the satisfier for a hemoccult result 716 is selected, screen 800 of FIG. 8 is opened.

Information for the hemoccult results for patient Jim Nasium 402 is entered into screen 800. A positive or negative finding depending on how many slides returned may be entered for stool occult blood results 804. Hemoccult results may be documented when one, two or three slides (818, 816 and 806 respectively) have been returned for the patient. Box 808 may be selected if three slides are returned negative. Boxes 810, 812 and 814 may be selected if one, two or all three of the slides are positive. The provider 820 who provides the stool occult blood results may be entered in field 820.

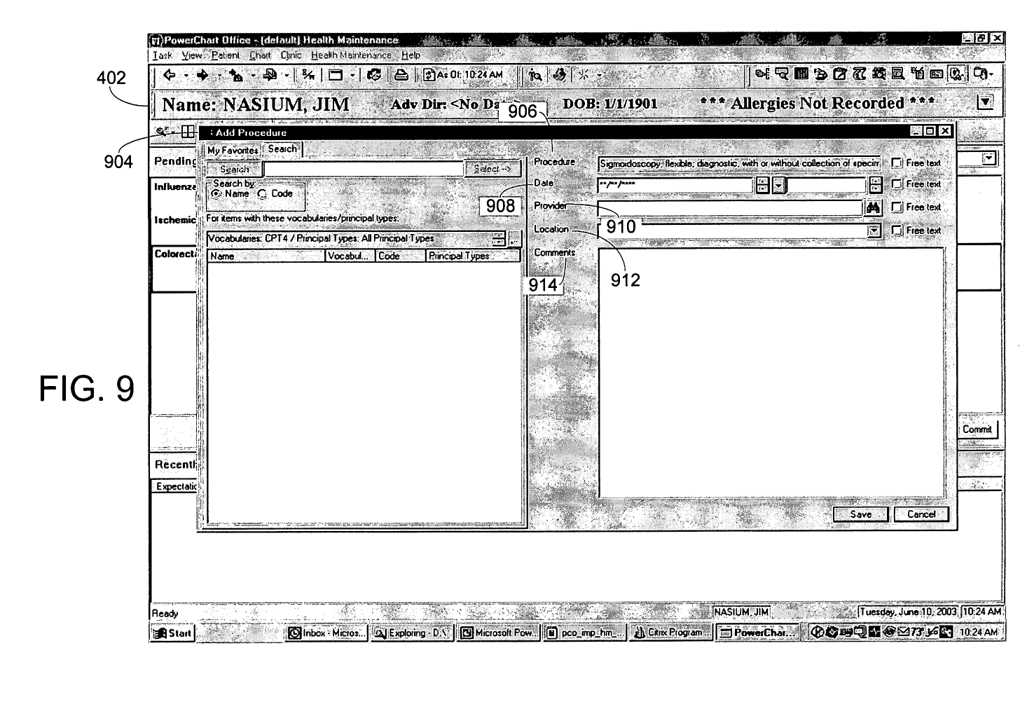

Referring again to FIG. 7, if the satisfier for a sigmoidoscopy 708 is selected, screen 904 of FIG. 9 is opened. Information for the sigmoidoscopy performed for patient Jim Nasium 402 may be entered into the add procedure screen 904. Information that may be added for a procedure includes the name of the procedure 906, the date of the procedure 908, the provider 910 and location 912 of the procedure and any comments 914. In the present example, information regarding the procedure for a sigmoidoscopy is entered to satisfy the expectation for colorectal screening for patient Jim Nasium 902.

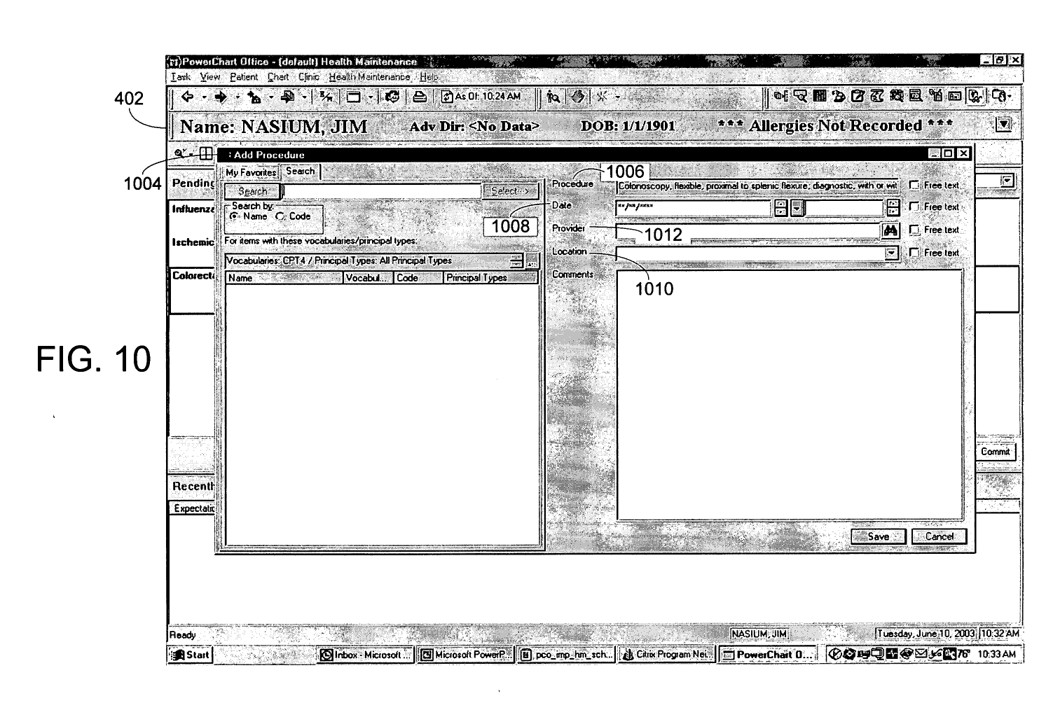

Referring to FIG. 7, in yet another example, if the satisfier for a colonoscopy 710 is selected, screen 1004 of FIG. 10 is opened. Information for the colonoscopy performed for patient Jim Nasium 402 may be entered into the add procedure screen 1004. The information for the colonoscopy may include the name of the procedure 1006, the date of the procedure 1008, the provider 1012 and location of the procedure 1010. In this example, the information regarding the colonoscopy is entered to satisfy the expectation for colorectal screening for patient Jim Nasium 402.

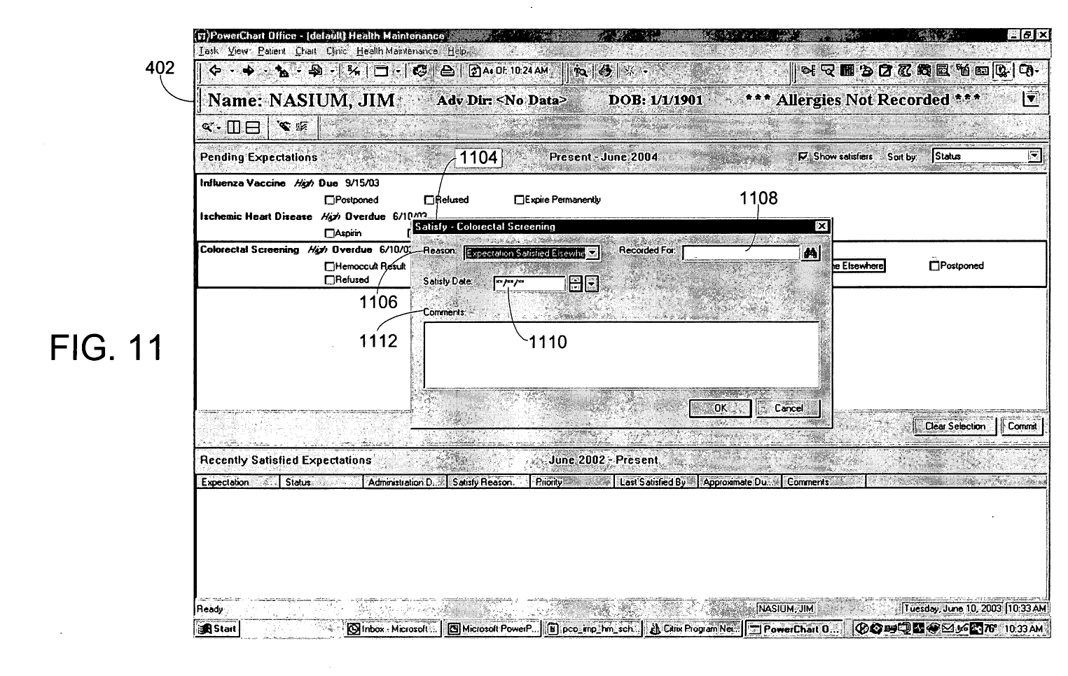

In still another example, if the satisfier for a hemoccult performed elsewhere 712 is selected, screen 1104 of FIG. 11 is opened. Information for the hemoccult performed elsewhere for patient Jim Nasium 402 may be entered into screen 1104. The reason the expectation is satisfied 1106 in this case is because the hemoccult was performed elsewhere, when recorded the satisfier 1108, the date satisfied 1110, and any comments 1112. In this example, the entry that a hemoccult was performed elsewhere satisfies the expectation for colorectal screening for patient Jim Nasium 402.

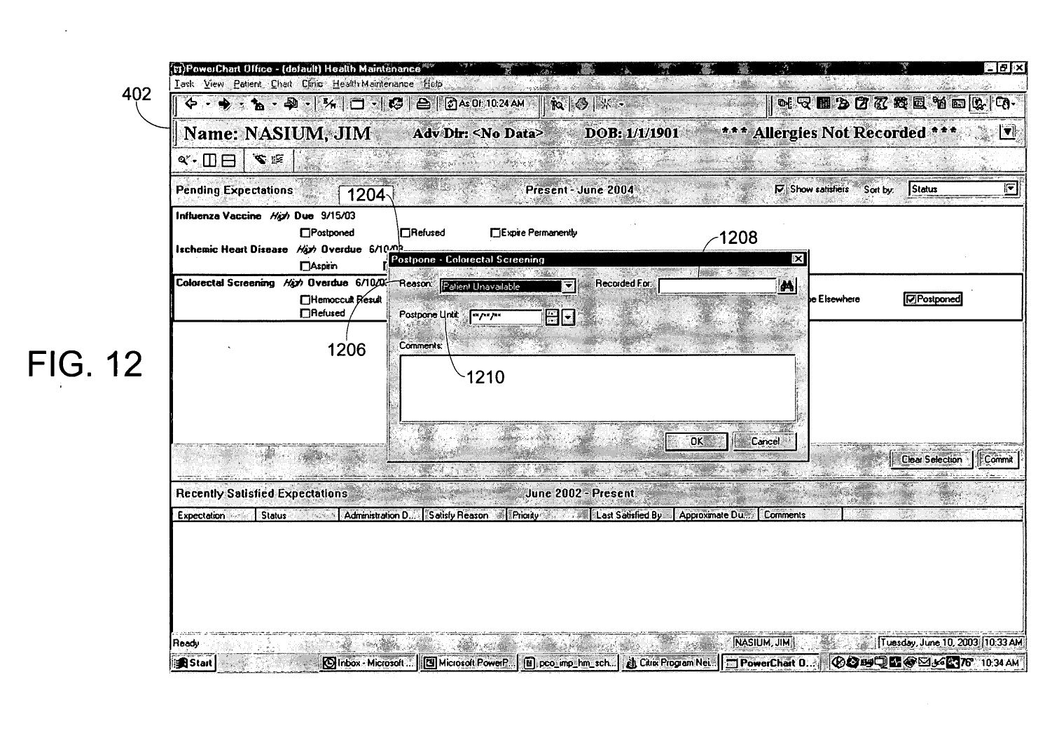

If postponement box 714 is selected in FIG. 7, screen 1204 of FIG. 12 is opened. Information regarding the postponement of the expectation for a health maintenance item (in this example, colorectal screening) for Jim Nasium 402 may be entered into screen 1204. The reason for the postponement is entered into field 1206, the person recording the postponement is entered into field 1208 and the date the expectation for the health maintenance item is entered into field 1210. In this example, the patient Jim Nasium 402 was unavailable 1206 for the colorectal screening. The postponement of the colorectal screening along with the date when the patient should receive the screening after postponement is stored for the patient. This information may be stored in a database, table and/or the patient's electronic medical record for later use.

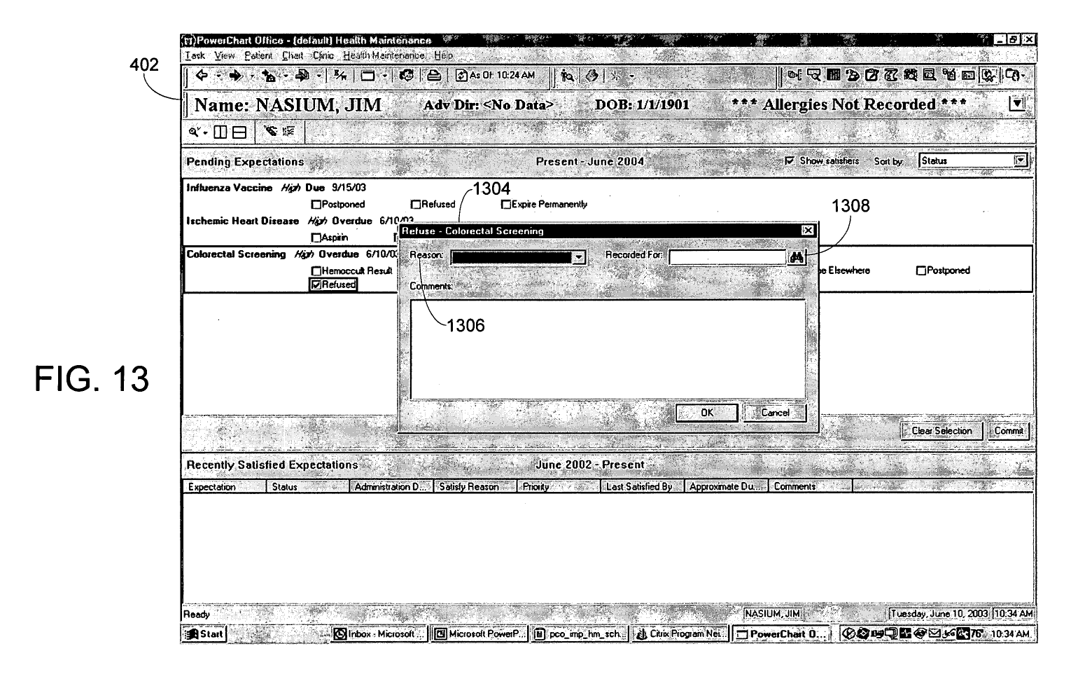

If refusal box 716 is selected in FIG. 7, screen 1304 of FIG. 13 is opened. Information regarding the refusal of the expectation for a health maintenance item for the patient 402 may be entered into screen 1304. The reason for refusal is entered into field 1306, the person recording the refusal is entered into field 1308 and any comments may also be entered. This refusal of the colorectal screening is stored in a database, table and/or the patient's electronic medical record and may be later used to show that the patient was informed of the need for colorectal screening but refused.

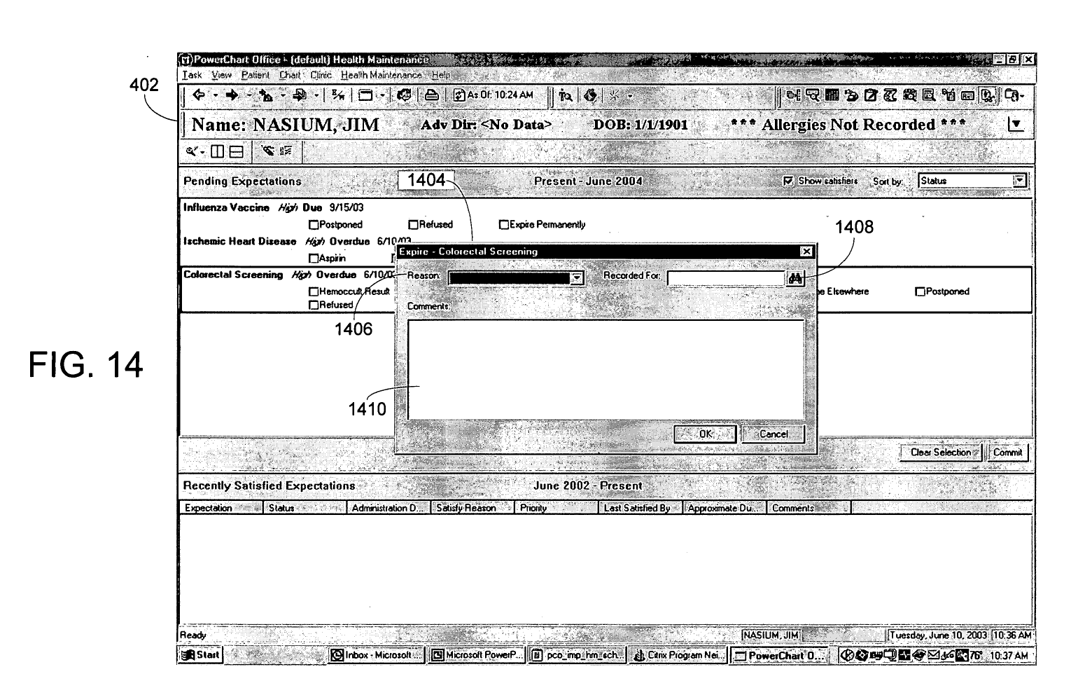

If the expire permanently box 718 is selected in FIG. 7, screen 1404 of FIG. 14 is opened. Information regarding the permanent expiration of the expectation for a health maintenance item for the patient 402 may be entered into screen 1404. The reason for permanent expiration is entered into field 1406, the person recording the permanent expiration is entered into field 1408 and any comments are entered in field 1410. Reasons for permanent expiration of an expectation for a health maintenance item may vary and include a terminal condition or diminished life expectancy. The permanent expiration information for the colorectal screening for the patient is stored in a database, table and/or the patient's electronic medical record.

As can be seen from the above description an illustrative example, the invention provides a method and system in a computerized environment for generating and storing health maintenance information for a patient. The present invention also provides a method and system in a computerized environment for generating satisfiers for an expectation for a health maintenance item and a method and system for determining whether a patient may experience an adverse reaction to a satisfier chosen for an expectation for a health maintenance item.

Although the invention has been described with reference to the preferred embodiment illustrated in the attached drawing figures, it is noted that substitutions may be made and equivalence employed herein without departing from the scope of the invention as recited in the claims. For example, additional steps may be added and steps removed without departing from the scope of the invention.

1. A method in a computer system for automatically determining whether an expectation for a health maintenance item has been satisfied, the method comprising:
generating an expectation for a health maintenance item for a person; and
automatically determining whether the expectation has been satisfied.

2. The method of claim 1, wherein the expectation is satisfied by searching an integrated database in a comprehensive healthcare system to determine if an existing order has been placed for the expectation.

3. The method of claim 1, wherein the expectation is satisfied by searching an integrated database in a comprehensive healthcare system to determine if a procedure has been documented.

4. The method of claim 1, wherein the expectation is satisfied by searching an integrated database in a comprehensive healthcare system to determine if one or more result values exist for the expectation.

5. The method of claim 1, wherein the expectation is satisfied by receiving an order for a satisfier for the expectation.

6. The method of claim 1, wherein the expectation is satisfied by receiving documentation of a result that is a satisfier for the expectation.

7. The method of claim 1, wherein the health maintenance item is one of a test, screening, therapy, and medication.

8. The method of claim 1, further comprising:
receiving a request for health maintenance items for a patient.

9. The method of claim 8, further comprising:
wherein the request is from a user.

10. The method of claim 9, further comprising:
obtaining information for the person from the person's electronic medical record in a comprehensive healthcare system.

11. The method of claim 10, further comprising:
obtaining one or more recommended health maintenance items.

12. The method of claim 11, further comprising:
obtaining the factors that would qualify a person for the one or more health maintenance items.

13. The method of claim 12, further comprising:
comparing the information for the person with the qualification factors to determine whether the person qualifies for one or more of the one or more recommended health maintenance items.

14. The method of claim 13, further comprising:
generating an expectation for each of the health maintenance items for which the patient qualifies.

15. A method in a computer system for generating satisfiers for an expectation for a health maintenance item, the method comprising:
obtaining one or more unsatisfied health maintenance item expectations for a person;
obtaining possible satisfiers for each of the one or more unsatisfied expectations; and
displaying the possible satisfiers for each of the one or more unsatisfied expectations.

16. The method of claim 15, wherein possible satisfiers are obtained from a pre-defined list for each health maintenance item stored in a database.

17. A method in a computer system for determining whether a patient may experience an adverse reaction to a satisfier chosen for an expectation for a health maintenance item, them method comprising:
receiving a satisfier for an expectation for a health maintenance item;
obtaining healthcare information for a person;
determining whether the person may have an adverse reaction to the satisfier; and
if so, warning of the possible adverse reaction to the satisfier.

18. The method of claim 17, wherein the satisfier is an order for a medication.

19. The method of claim 18, wherein the system determines whether the person is allergic to the medication.

20. The method of claim 17, wherein the healthcare information for a person is obtained for the patient's electronic medical record in a comprehensive healthcare environment.

21. The method of claim 17, further comprising:
obtaining information regarding possible adverse reactions to the satisfier from a database.

22. The method of claim 21, further comprising:
comparing the information regarding possible adverse reactions to healthcare information for the person to determine whether the person may have an adverse reaction to the satisfier.

23. A computerized system for automatically determining whether an expectation for a health maintenance item has been satisfied, the system comprising:
a generating module for generating an expectation for a health maintenance item for a person; and
a determining module for automatically determining whether the expectation has been satisfied.

24. The system of claim 23, wherein the expectation is satisfied by searching an integrated database in a comprehensive healthcare system to determine if an existing order has been placed for the expectation.

25. The system of claim 23, wherein the expectation is satisfied by searching an integrated database in a comprehensive healthcare system to determine if a procedure has been documented.

26. The system of claim 23, wherein the expectation is satisfied by searching an integrated database in a comprehensive healthcare system to determine if one or more result values exist for the expectation.

27. The system of claim 23, wherein the expectation is satisfied by receiving an order for a satisfier for the expectation.

28. The system of claim 23, wherein the expectation is satisfied by receiving documentation of a result that is a satisfier for the expectation.

29. The system of claim 23, wherein the health maintenance item is one of a test, screening, therapy, and medication.

30. The system of claim 23, further comprising:
an obtaining module for obtaining information for the person from the person's electronic medical record in a comprehensive healthcare system.

31. The system of claim 30, further comprising:
a second obtaining module for obtaining one or more recommended health maintenance items.

32. The system of claim 31, further comprising:
a third obtaining module for obtaining the factors that would qualify a person for the one or more health maintenance items.

33. The system of claim 32, further comprising:
a comparing module for comparing the information for the person with the qualification factors to determine whether the person qualifies for one or more of the one or more recommended health maintenance items.

34. The system of claim 33, further comprising:
a storing module for storing the satisfied and unsatisfied expectations in the person's electronic medical record in a comprehensive healthcare system.

35. A computerized system for generating satisfiers for an expectation for a health maintenance item, the system comprising:
an obtaining module for obtaining one or more unsatisfied health maintenance item expectations for a person;
a second obtaining module for obtaining possible satisfiers for each of the one or more unsatisfied expectations; and
a displaying module for displaying the possible satisfiers for each of the one or more unsatisfied expectations.

36. The system of claim 35, wherein possible satisfiers are obtained from a pre-defined list for each health maintenance item stored in a database.

37. A computerized system for determining whether a patient may experience an adverse reaction to a satisfier chosen for an expectation for a health maintenance item, them method comprising:
a receiving module for receiving a satisfier for an expectation for a health maintenance item;
an obtaining module for obtaining healthcare information for a person;
a determining module for determining whether the person may have an adverse reaction to the satisfier; and
a warning module for warning of the possible adverse reaction to the satisfier.

38. The system of claim 35, wherein the satisfier is an order for a medication.

39. The method of claim 38, wherein the system determines whether the person is allergic to the medication.

40. The system of claim 37, wherein the healthcare information for a person is obtained for the patient's electronic medical record in a comprehensive healthcare environment.

41. The system of claim 40, further comprising:
a second obtaining module for obtaining information regarding possible adverse reactions to the satisfier from a database.

42. The system of claim 41, further comprising:
a comparing module for comparing the information regarding possible adverse reactions to healthcare information for the person to determine whether the person may have an adverse reaction to the satisfier.

43. A system in a computerized environment for automatically determining whether an expectation for a health maintenance item has been satisfied, the method comprising:
means for generating an expectation for a health maintenance item for a person; and
means for automatically determining whether the expectation has been satisfied.

44. A computer-readable medium having computer-executable instructions for performing a method, the method comprising:
generating an expectation for a health maintenance item for a person; and
automatically determining whether the expectation has been satisfied.

45. A system in a computerized environment for generating satisfiers for an expectation for a health maintenance item, the method comprising:
means for obtaining one or more unsatisfied health maintenance item expectations for a person;
means for obtaining possible satisfiers for each of the one or more unsatisfied expectations; and
means for displaying the possible satisfiers for each of the one or more unsatisfied expectations.

46. A computer-readable medium having computer-executable instructions for performing a method, the method comprising:
obtaining one or more unsatisfied health maintenance item expectations for a person;
obtaining possible satisfiers for each of the one or more unsatisfied expectations; and
displaying the possible satisfiers for each of the one or more unsatisfied expectations.

47. A system in a computerized environment for determining whether a patient may experience an adverse reaction to a satisfier chosen for an expectation for a health maintenance item, them method comprising:
means for receiving a satisfier for an expectation for a health maintenance item;
means for obtaining healthcare information for a person;
means for determining whether the person may have an adverse reaction to the satisfier; and
if so, warning of the possible adverse reaction to the satisfier.

48. A computer-readable medium having computer-executable instructions for performing a method, the method comprising:
receiving a satisfier for an expectation for a health maintenance item;
obtaining healthcare information for a person;
determining whether the person may have an adverse reaction to the satisfier; and
if so, warning of the possible adverse reaction to the satisfier.
